(19) United States
(12) Patent Application Publication
(10) Pub. No.: US 2012/0134243 A1
(43) Pub. Date: May 31, 2012

(54) ELECTRONIC DEVICE AND WATCH

(75) Inventor: Hiroyuki Sonoda, Tokyo (JP)

(73) Assignee: CASIO COMPUTER CO., LTD., Tokyo (JP)

(21) Appl. No.: 13/305,851

(22) Filed: Nov. 29, 2011

(30) Foreign Application Priority Data
Nov. 29, 2010 (JP) 2010-264819

(51) Int. Cl. G04C 3/00

(52) U.S. Cl. 368/205

(57) ABSTRACT

Disclosed is an electronic device in which a transparent member, a decorative plate, and a solar panel are arranged in this order in a metallic device case from an end side of an opening of the device case, wherein the decorative plate has light permeability and has a light refractive part made of a concavo-convex portion on a surface of the decorative plate on the side of the solar panel, and a semi-transmissive reflective plate having both light permeability and light reflectivity is provided between the decorative plate and the solar panel, and the semi-transmissive reflective plate has metal-free vapor deposited film.

### CROSS-REFERENCE TO RELATED APPLICATIONS

This application is based upon and claims the benefit of priority under 35 USC 119 of Japanese Patent Application No. 2010-264819 filed on Nov. 29, 2010, the entire disclosure of which, including the description, claims, drawings, and abstract, is incorporated herein by reference.

### BACKGROUND OF THE INVENTION

1. Field of the Invention

The present invention relates to an electronic device and a watch provided with a solar panel.

2. Description of Related Art

In a watch having a solar panel, the solar panel is installed on the back side of a clock face. Therefore, it is necessary that the clock face is constructed of a light transmissive member so that external light is led to the solar panel through the clock face on the front side. However, a solar panel has a unique ground color of deep purple and if a clock face is formed of a light transmissive member, the deep purple ground color of the solar panel becomes visible from outside of a watch glass.

Therefore, as previously presented in Japanese Unexamined Patent Application Publication No. 2005-189019, a watch is known which is structured where a prism reflective surface is formed on the lower surface of a clock face and a reflective polarizing plate is provided on the back side of the clock face to eliminate the deep purple color of the solar panel provided on the back side of the reflective polarizing plate. Thereby, the deep purple color of the solar panel becomes difficult to be visually recognized from outside of a watch glass.

According to the invention described in Japanese Unexamined Patent Application Publication No. 2005-189019, because of the interaction between the prism reflective surface and the reflective polarizing plate, the deep purple color, which is the ground color of the solar panel, is made difficult to be visible from outside of the watch glass. However, the ground color of deep purple can be visible from some angles, and it was hard to make it completely invisible.

### SUMMARY OF THE INVENTION

The object of the present invention is to provide an electronic device and a watch which are enabled to unfailingly prevent deep purple color of a solar panel from being visible from outside.

According to an aspect of the present invention, there is provided an electronic device in which a transparent member, a decorative plate, and a solar panel are arranged in this order in a metallic device case from an end side of an opening of the device case, wherein

the decorative plate has light permeability and has a light refractive part made of a concavo-convex portion on a surface of the decorative plate on the side of the solar panel, and

a semi-transmissive reflective plate having both light permeability and light reflectivity is provided between the decorative plate and the solar panel, and the semi-transmissive reflective plate has metal-free vapor deposited film.

According to another aspect of the present invention, there is provided an electronic device in which a transparent member, a decorative plate, a solar panel and an antenna device are arranged in this order in a metallic device case from an end side of an opening of the device case, wherein

the decorative plate has light permeability and has a light refractive part made of a concavo-convex portion on a surface of the decorative plate on the side of the solar panel, and

a semi-transmissive reflective plate having light permeability, light reflectivity, as well as radio-wave permeability is provided between the decorative plate and the solar panel, and the semi-transmissive reflective plate has metal-free vapor deposited film.

According to this invention, a metal-free vapor deposited film is optically transmissive only partially, and light is refracted by a light refractive part, thereby a ground color of the solar panel which is deep purple becomes difficult to be visible. In addition, since the metal-free vapor deposited film has a peculiar color, the deep purple color of the solar panel can be surely prevented from being visible from outside.

Moreover, according to this invention, since a semi-transmissive reflective part having light permeability, light reflectivity, as well as radio-wave permeability is provided, the deep purple color of the solar panel is surely prevented from being visible from outside because of a synergy between a light refractive effect from the light refractive part formed by a concavo-convex portion and light reflective effect from the semi-transmissive reflective part while maintaining good radio-wave receiving sensitivity of an antenna device.

### BRIEF DESCRIPTION OF THE DRAWINGS

The present invention will become more fully understood from the detailed description given hereinbelow and the appended drawings, and thus are not intended as a definition of the limits of the present invention, wherein;

FIG. 1 is a plan view of a main body of a watch according to the first embodiment;

FIG. 2 is a cross-sectional view taken along the line II-II of the main body of the watch depicted in FIG. 1;

FIG. 3 is a cross-sectional view partially showing a clock face, a semi-transmissive reflective plate, and a solar panel inside the main body of the watch shown in FIG. 2;

FIGS. 4A and 4B are views showing the clock face of FIG. 3, where FIG. 4A is a partial cross-sectional side view of the clock face and FIG. 4B is a bottom plan view showing a structure of a light refractive part of the clock face;

FIG. 5 is an enlarged cross-sectional view of the semi-transmissive reflective plate of FIG. 3;

FIG. 6 is an enlarged cross-sectional view of a semi-transmissive reflective plate of a watch according to the second embodiment;

FIG. 7 is a cross-sectional view partially showing a clock face, a semi-transmissive reflective plate, and a solar panel inside a main body of a watch according to the third embodiment;

FIG. 8 is an enlarged cross-sectional view of a semi-transmissive reflective plate of FIG. 6; and

FIG. 9 is a cross-sectional view partially showing a clock face, a semi-transmissive reflective plate, and a solar panel inside a main body of a watch according to the fourth embodiment.

### DESCRIPTION OF THE PREFERRED EMBODIMENT

### First Embodiment

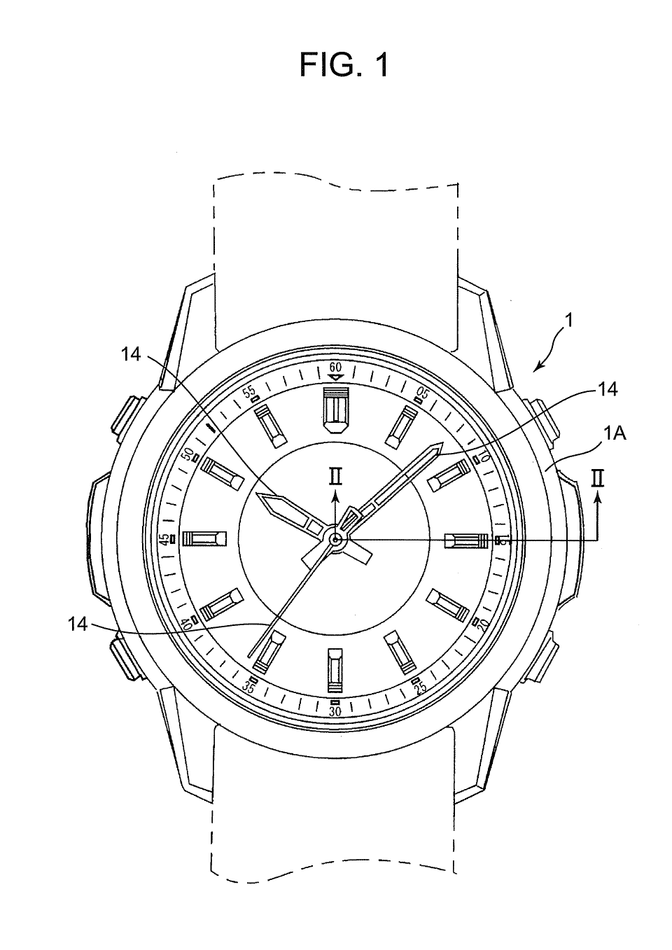

The first embodiment will be explained below with reference to FIGS. 1 to 5. The article for the first embodiment is a watch as an example of electronic devices.

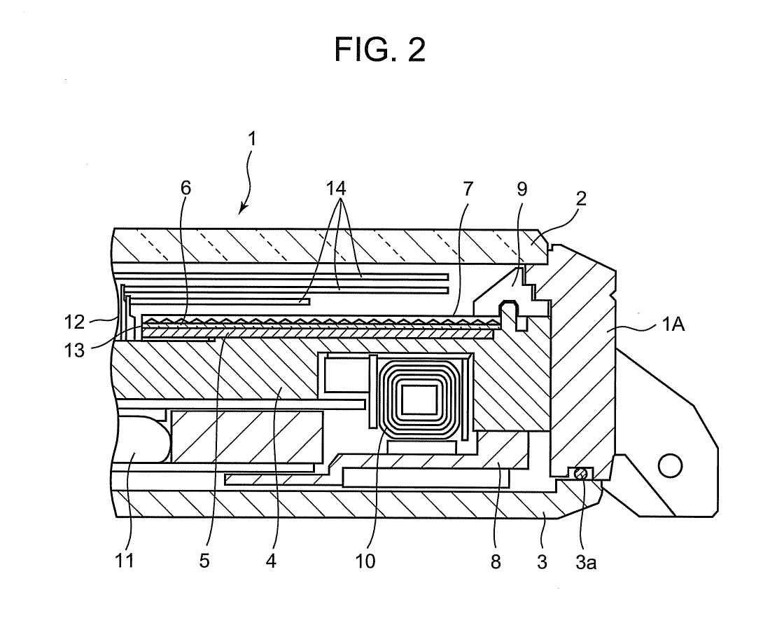

FIG. 1 is a plan view of the main body of the watch according to the first embodiment, and FIG. 2 is a cross-sectional side view partially showing the side surface of the main body of the watch.

As depicted in FIGS. 1 and 2, on the top surface of a metallic watch case 1A of a watch 1, a watch glass 2 serving as a transparent member is attached, and a back cover 3 is attached on the bottom surface of the same with a waterproof ring 3a provided therebetween. The watch case 1A is formed of a metallic material. Inside the watch case 1A, a watch module 4 is accommodated. On top of the watch module 4, a solar panel 5, a semi-transmissive reflective plate 6, and a clock face 7 are provided in this order within the watch case 1A.

The watch module 4, the solar panel 5, the semi-transmissive reflective plate 6 and the clock face 7 are provided as being sandwiched between a holding ring 8 from the bottom and a panel cover 9 from the top within the watch case 1A.

Also, inside the watch case 1A, an antenna device 10 and a secondary battery 11 connected to the antenna device 10 are provided below the watch module 4.

As explained above, the metallic watch case 1A is provided with the watch glass 2, the clock face 7, the semi-transmissive reflective plate 6, the solar panel 5, the watch module 4, and the antenna device 10 in this order from an end side of an opening thereof.

Note that, inside the watch case 1A, a hand shaft 12 projects upwards through a through hole 13 formed in the solar panel 5, the semi-transmissive reflective plate 6 and the clock face 7, and hands 14 including a hour hand, a minute hand, and a second hand are attached to an upper part of the projecting hand shaft 12.

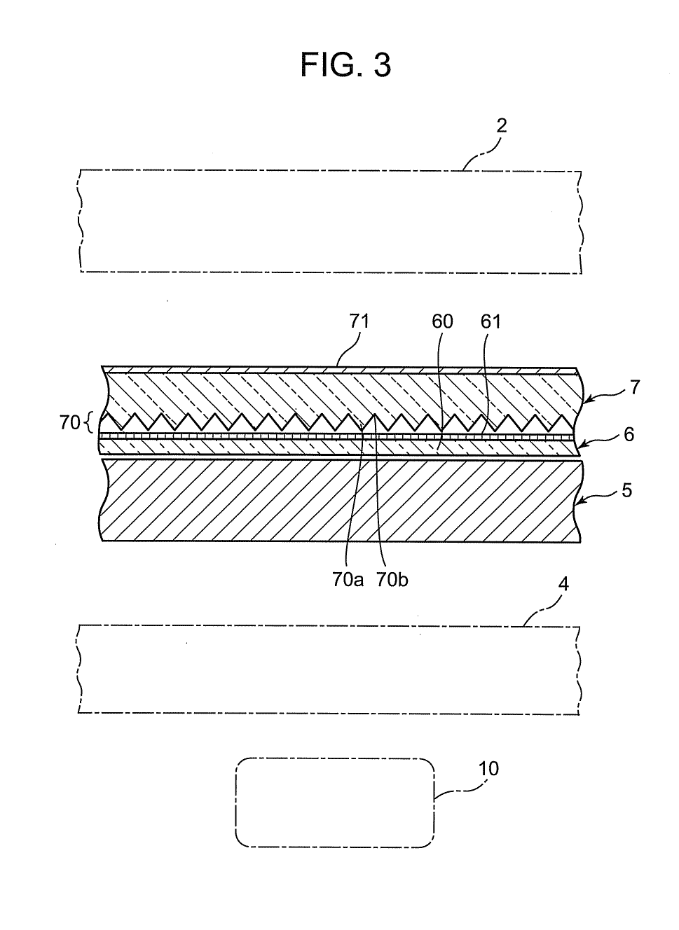

FIG. 3 is a cross-sectional view partially showing the clock face 7, the semi-transmissive reflective plate 6, and the solar panel 5 inside the main body of the watch 1A.

Here, the clock face 7 provided underneath the watch glass 2 constitutes a decorative plate. The clock face 7 is formed into a plate shape from a transparent or semi-transparent glass or synthetic resin, and has light permeability. On the lower surface of the clock face 7, a light refractive part 70 is formed.

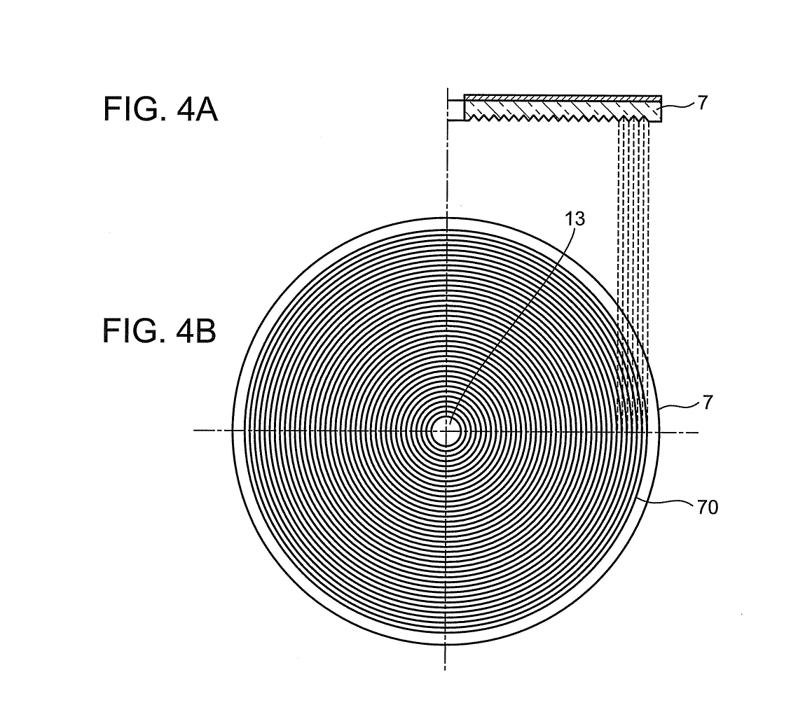

FIG. 4A is a partially-omitted cross-sectional side view of the clock face 7, and FIG. 4B is a bottom plan view of the clock face 7.

The light refractive part 70 of the clock face 7 is formed from mountain-shaped portions 70a in a circular shape and valley-shaped portions 70b located next to and between the said mountain-shaped portions 70a. Slanted surfaces which form the mountain-shaped portions 70a and the valley-shaped portions 70b form a glossy surface and work as a reflective surface. Note that the light refractive part 70 may also be formed in a spiral shape. Also, the light refractive part 70 may be formed into a number of pyramid or conical-shaped small prisms, for example. Moreover, although the light refractive part 70 is formed into a triangle-wave cross-sectional shape in this embodiment, it may also be formed in a saw-tooth cross-sectional shape.

The light refractive part 70 is required to have light refractive function and light reflective function. Because of the light refractive function and the light reflective function, the ground color of the solar panel 5 becomes hard to be visible, and an amount of light travelling toward the solar panel 5 can be increased as much as possible.

Note that the upper surface of the clock face 7 has matte printing 71. Alternatively, the upper surface of the clock face 7 may have pear-skin finish instead of the printing 71.

Furthermore, the semi-transmissive reflective plate 6 provided below the clock face 7 is comprised of a light-transmissive base material 60 and a metal-free vapor deposited film 61 which serves as a semi-transmissive reflective part formed on the base material 60 on the side of the clock face 7. Here, the metal-free vapor deposited film means a vapor deposited film which is deposited using various different materials including a nonconductive body, a dielectric body, or inorganic or non-metallic materials having an extremely low level of radio-wave shielding and a high level of radio-wave permeability.

The base material 60 is formed into a plate shape from transparent or semi-transparent glass or synthetic resin.

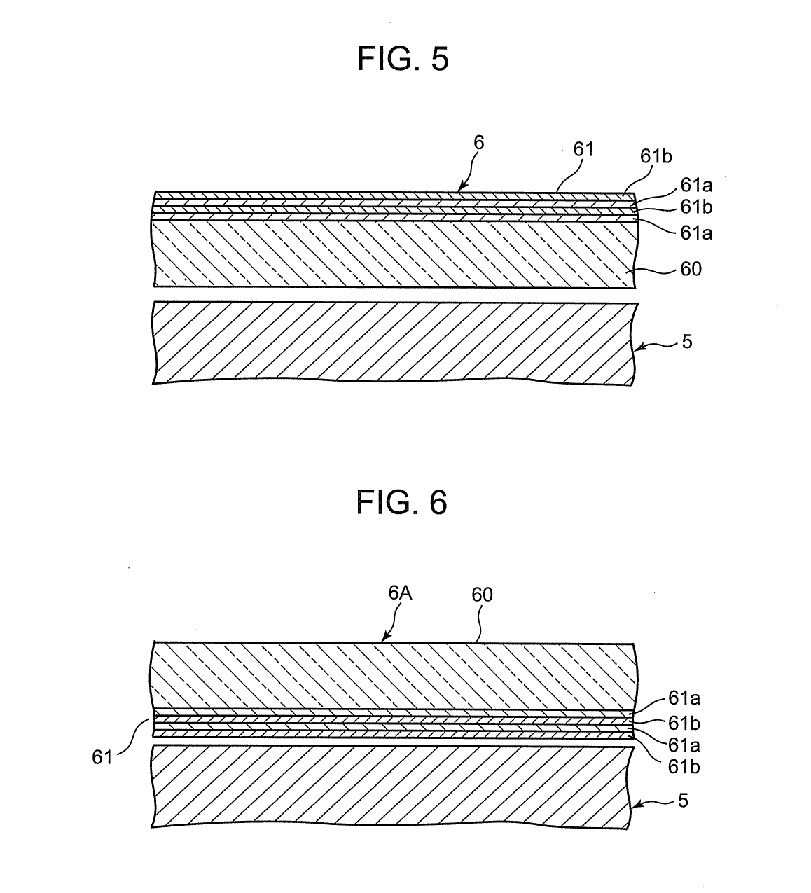

On the other hand, as shown in FIG. 5, the metal-free vapor deposited film 61 has a 4-layered structure in which a low refractive index metal-free compound layer 61a made from a metal-free compound with a low refractive index and a high refractive index metal-free compound layer 61b made from a metal-free compound with high refractive index of which refractive index is higher than that of the low refractive index metal-free compound layer 61a are laminated on each other.

Specifically, the low refractive index metal-free compound is a substance selected from magnesium fluoride, calcium fluoride, silicon monoxide, silicon dioxide, and lithium fluoride, and the high refractive index metal-free compound is a substance selected from titanium oxide, zinc sulfide, tantalum oxide, zinc selenide, and zirconium dioxide.

By forming the metal-free vapor deposited film 61 with the low refractive index metal-free compound layer 61a and the high refractive index metal-free compound layer 61b as explained above, an effect of optical interference is produced, and different interference colors are generated in different angles. Moreover, a specific wavelength is selectively reflected, thus generating a peculiar color decided by a layer structure. As a result, the peculiar color and interference colors demonstrate high decorativeness.

For example, if the low refractive index metal-free compound layer 61a is formed from a silicon dioxide (SiO2) layer, and the high refractive index metal-free compound layer 61b is formed from a zirconium dioxide (ZrO2) layer, the color viewed from the side of the watch glass 2 can be silver. In this case, for the metal-free vapor deposited film 61 having a 4-layered structure, the overall thickness may be between tens and hundreds of nm. To be more specific, it is preferred to make the overall thickness to 120+/−20 nm in order to surely eliminate the deep purple ground color of the solar panel 5 without blocking radio-wave permeability.

Here, the metal-free vapor deposited layer 61 has the structure of, but not limited to, the 4-layered structure, but may also have a structure of a single to three layers, or 5 or more layers.

According to the watch 1 of the foregoing first embodiment, the following effects are obtained.

Since the metal-free vapor deposited layer 61 is light transmissive only partially and light is refracted by the light refractive part 70, the deep purple, the ground color of the solar panel 5, becomes hard to be visible. In addition, the metal-free vapor deposited film 61 has a peculiar color, thus enabling to surely prevent the deep purple color of the solar panel from being visible from outside. Moreover, since the metal-free vapor deposited film 61 serves as the semi-transmissive reflective part of the semi-transmissive reflective plate 6, radio-wave permeability is not prevented, thus a watch is enabled to have excellent radio-wave receiving characteristics.

Moreover, since the metal-free vapor deposited film 61 has its peculiar color derived from the layered structure thereof, the color visible from the side of the watch glass 2 can be a desired color. In the case of this embodiment, the low refractive index metal-free compound layer 61a is formed from a silicon dioxide (SiO2) layer and the high refractive index metal-free compound layer 61b is formed from a zirconium dioxide (ZrO2) layer, so the color viewed from the side of the watch glass 2 can be silver, making the clock face and watch look high quality.

### Second Embodiment

Next, the second embodiment will be described with reference to FIG. 6.

FIG. 6 is an enlarged cross-sectional view of a semi-transmissive reflective plate of a watch according to the second embodiment.

The watch 1 of the second embodiment has a semi-transmissive reflective plate 6A formed of a base material 60 and a metal-free vapor deposited film 61, which is the same as the semi-transmissive reflective plate 6 of the watch 1 of the first embodiment.

However, the watch 1 of the second embodiment is different from the watch 1 of the first embodiment in that the metal-free vapor deposited film 61 is formed on the bottom surface of the base material 60 in the semi-transmissive reflective plate 6A.

Otherwise, the watch 1 of the second embodiment has the same structure as the watch 1 of the first embodiment. Therefore, the descriptions and drawings thereof will be omitted.

According to the watch 1 of the second embodiment, as well as similar effects as those of the watch 1 of the first embodiment are obtained, abrasion of the metal-free vapor deposited film 61 is surely prevented because the metal-free vapor deposited film 61 is formed on the bottom surface of the base material 60 located underneath the clock face 7 so that the surface thereof may abut on the surface of the flat solar panel 5 but the metal-free vapor deposited film 61 does not abut on the sharp mountain-shaped portions 70a of the light refractive part 70 of the clock face 7.

### Third Embodiment

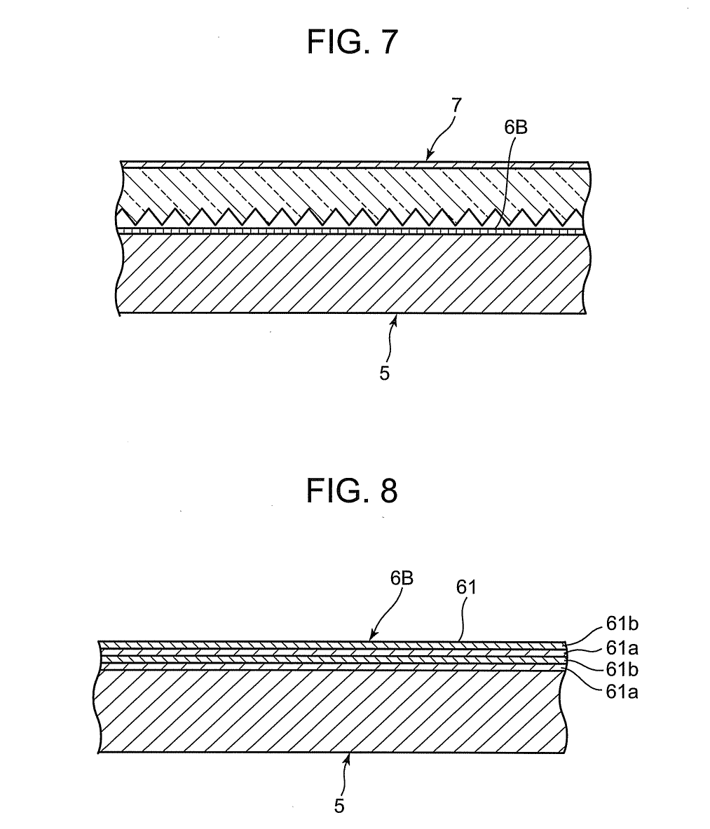

Next, the third embodiment will be explained with reference to FIGS. 7 and 8.

FIG. 7 is a cross-sectional view partially showing a clock face, a semi-transmissive reflective plate, and a solar panel inside a main body of a watch according to the third embodiment, and FIG. 8 is an enlarged cross-sectional view of the semi-transmissive reflective plate.

The watch 1 of the third embodiment is different from the watch 1 of the first embodiment in that a semi-transmissive reflective part 6B is formed solely by a metal-free vapor deposited film 61 and the metal-free vapor deposited film 61 is integrated with a solar panel 5.

This means that, in the watch 1 of the third embodiment, the solar panel 5 is used as a substitute of the base material 60 of the watch 1 of the first embodiment.

Otherwise, the watch 1 of the third embodiment has the same structure as the watch 1 of the first embodiment, so the description and drawings thereof will be omitted.

According to the watch 1 of the third embodiment, as well as similar effects as those of the watch 1 of the first embodiment are obtained, it becomes possible to make the watch 1 thinner because the metal-free vapor deposited film 61 is formed directly on the solar panel 5 and no special base material is needed in order to support the metal-free vapor deposited film 61 so that the number of parts can be reduced and the distance between the solar panel 5 and the clock face 7 can be reduced.

### Fourth Embodiment

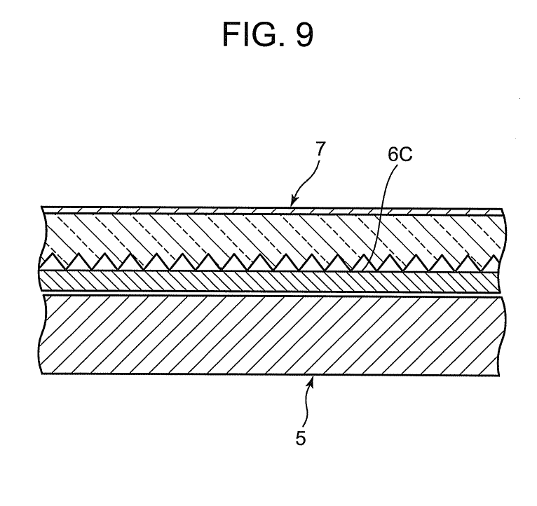

Next, the fourth embodiment will be explained with reference to FIG. 9.

FIG. 9 is a cross-sectional view partially showing a clock face, a semi-transmissive reflective plate, and a solar panel inside a main body of a watch according to the forth embodiment.

In the watch 1 of the fourth embodiment, the semi-transmissive reflective part 6C is formed of a laminate film 62. The laminate film 62 is made of at least 30 layers of plastic resin layers with different light refractive indexes alternately stacked on each other in the thickness direction.

As a specific example of the laminate film 62, there is a product called PICASUS manufactured by TORAY Industries, Inc., which has a reflectivity of 30% or higher at the wavelength of 400 to 1000 nm. Also, the laminate film described in Japanese Unexamined Patent Application Publication No. 2008-200861 may be used as another specific example of the laminate film 62.

The rest of the structure is the same as that of the watch of the first embodiment, so the description and drawings thereof will be omitted.

According to the watch 1 of the fourth embodiment, the deep purple color of the solar panel 5 can be effectively removed similarly to the watch 1 of the first embodiment.

As described above, the embodiment of the present invention is characterized in that there is provided an electronic device (watch 1 of FIG. 2) in which a transparent member (watch glass 2 of FIG. 2), a decorative plate (clock face 7 of FIG. 2), and a solar panel (solar panel 5 of FIG. 2) are arranged in this order in a metallic device case (watch case 1A of FIG. 2) from an end side of an opening of the device case, wherein

the decorative plate has light permeability and has a light refractive part (light refractive part 70 of FIG. 3) made of a concavo-convex portion on a surface of the decorative plate on the side of the solar panel, and

a semi-transmissive reflective plate (semi-transmissive reflective plate 6 of FIG. 2) having both light permeability and light reflectivity is provided between the decorative plate and the solar panel, and the semi-transmissive reflective plate has metal-free vapor deposited film (metal-free vapor deposited film 61 of FIG. 2).

Further, embodiment of the present invention is characterized in that there is also provided an electronic device (watch 1 of FIG. 2) in which a transparent member (watch glass 2 of FIG. 2), a decorative plate (clock face 7 of FIG. 2), a solar panel (solar panel 5 of FIG. 2) and an antenna device (antenna device 10 of FIG. 2) are arranged in this order in a metallic device case (watch case 1A of FIG. 2) from an end side of an opening of the device case, wherein

the decorative plate has light permeability and has a light refractive part (light refractive part 70 of FIG. 3) made of a concavo-convex portion on a surface of the decorative plate on the side of the solar panel, and

a semi-transmissive reflective plate (semi-transmissive reflective plate 6 of FIG. 2) having light permeability, light reflectivity, as well as radio-wave permeability is provided between the decorative plate and the solar panel, and the semi-transmissive reflective plate has metal-free vapor deposited film (metal-free vapor deposited film 61 of FIG. 2).

Further, the electronic device is characterized in that the metal-free vapor deposited film (semi-transmissive reflective plate 6A of FIG. 6) is formed on a surface of a light-transmissive base material provided between the decorative plate and the solar panel on the side of the decorative plate or the solar panel.

Further, the electronic device is characterized in that a semi-transmissive reflective part (semi-transmissive reflective part 6B of FIG. 7) made of the metal-free vapor deposited film is formed in stead of the semi-transmissive reflective plate on a surface of the solar panel on the side of the decorative plate.

Further, the electronic device is characterized in that the metal-free vapor deposited film is structured by alternately stacking two or more layers of a low refractive index metal-free compound layer (low refractive index metal-free compound layer 61a of FIG. 5) made from a low refractive index metal-free compound and a high refractive index metal-free compound layer (high refractive index metal-free compound layer 61b of FIG. 5) made of a high refractive index metal-free compound having a higher refractive index than that of the low refractive index metal-free compound.

Further, the electronic device is characterized in that the low refractive index metal-free compound is a substance selected from magnesium fluoride, calcium fluoride, silicon monoxide, silicon dioxide, and lithium fluoride, and the high refractive index metal-free compound is a substance selected from titanium oxide, zinc sulfide, tantalum oxide, zinc selenide, and zirconium dioxide.

Further, the electronic device is characterized in that the metal-free vapor deposited film has a four-layer structure in which a silicon dioxide film and a zirconium dioxide film are alternately stacked on each other.

More over, the embodiment of the present invention is characterized in that there is provided a watch (1) comprising:

a light-transmissive clock face (7) having a light refractive part formed from a concavo-convex portion on the bottom surface;

a solar panel (5) provided underneath the clock face; and

a semi-transmissive reflective plate (6) having both light permeability and light reflectivity provided between the clock face and the solar panel,

wherein the semi-transmissive reflective plate has a metal-free vapor deposited film (61).

Further, embodiment of the present invention is characterized in that there is also provided a watch (1) comprising:

a light transmissive clock face (7) having a light refractive part formed from a concavo-convex portion on the bottom surface thereof;

a solar panel (5) provided underneath the clock face;

an antenna device (10) provided underneath the solar panel; and

a semi-transmissive reflective plate (6) having both light permeability, light reflectivity, as well as radio-wave permeability provided between the clock face and the solar panel,

wherein the semi-transmissive reflective plate has a metal-free vapor deposited film (61).

Further, the electronic device is characterized in that the metal-free vapor deposited film (semi-transmissive reflective plate 6A of FIG. 6) is formed on a surface of a light-transmissive base material provided between the clock face and the solar panel on the side of the clock face or the solar panel.

Further, the electronic device is characterized in that a semi-transmissive reflective part (semi-transmissive reflective part 6B of FIG. 7) made of the metal-free vapor deposited film is formed in stead of the semi-transmissive reflective plate on a surface of the solar panel on the side of the clock face.

Further, the electronic device is characterized in that the metal-free vapor deposited film is structured by alternately stacking two or more layers of a low refractive index metal-free compound layer (61a) made from a low refractive index metal-free compound and a high refractive index metal-free compound layer (61b) made of a high refractive index metal-free compound having a higher refractive index than that of the low refractive index metal-free compound.

Further, the electronic device is characterized in that the low refractive index metal-free compound is a substance selected from magnesium fluoride, calcium fluoride, silicon monoxide, silicon dioxide, and lithium fluoride, and the high refractive index metal-free compound is a substance selected from titanium oxide, zinc sulfide, tantalum oxide, zinc selenide, and zirconium dioxide.

Further, the electronic device is characterized in that the metal-free vapor deposited film has a four-layer structure in which a silicon dioxide film and a zirconium dioxide film are alternately stacked on each other.

The embodiments of the present inventions are described above, but the present invention is not limited to these embodiments and various changes may be made without departing from the spirit and scope of the invention.

For example, in these embodiments, the semi-transmissive reflective plate or semi-transmissive reflective part is structured by combining the low refractive index metal-free compound layer and the high refractive index metal-free compound layer, but may instead be structured by combining a medium refractive index metal-free compound layer such as alumina, which is a medium refractive index metal-free compound, in addition to the low refractive index metal-free compound layer and the high refractive index metal-free compound layer. This means that the semi-transmissive reflective plate or semi-transmissive reflective part may be structured by combining the low refractive index metal-free compound and the medium refractive index metal-free compound or combining the high refractive index metal-free compound and the medium refractive index metal-free compound.

Furthermore, in the above-described embodiments, a watch was used as an example of electronic devices. However, the present invention may also be generally applied to an electronic device provided with a device case as the watch case 1A, a transparent member as the watch glass 2, a decorative plate as the clock face 7, and a solar panel, as well as to an electronic device having an antenna device in addition to the said parts.

What is claimed is:

1. An electronic device in which a transparent member, a decorative plate, and a solar panel are arranged in this order in a metallic device case from an end side of an opening of the device case, wherein
the decorative plate has light permeability and has a light refractive part made of a concavo-convex portion on a surface of the decorative plate on the side of the solar panel, and
a semi-transmissive reflective plate having both light permeability and light reflectivity is provided between the decorative plate and the solar panel, and the semi-transmissive reflective plate has metal-free vapor deposited film.

2. An electronic device in which a transparent member, a decorative plate, a solar panel and an antenna device are arranged in this order in a metallic device case from an end side of an opening of the device case, wherein
the decorative plate has light permeability and has a light refractive part made of a concavo-convex portion on a surface of the decorative plate on the side of the solar panel, and
a semi-transmissive reflective plate having light permeability, light reflectivity, as well as radio-wave permeability is provided between the decorative plate and the solar panel, and the semi-transmissive reflective plate has metal-free vapor deposited film.

3. The electronic device according to claim 1, wherein the metal-free vapor deposited film is formed on a surface of a light-transmissive base material provided between the decorative plate and the solar panel on the side of the decorative plate or the solar panel.

4. The electronic device according to claim 1, wherein a semi-transmissive reflective part made of the metal-free vapor deposited film is formed in stead of the semi-transmissive reflective plate on a surface of the solar panel on the side of the decorative plate.

5. The electronic device according to claim 1, wherein the metal-free vapor deposited film is structured by alternately stacking two or more layers of a low refractive index metal-free compound layer made from a low refractive index metal-free compound and a high refractive index metal-free compound layer made of a high refractive index metal-free compound having a higher refractive index than that of the low refractive index metal-free compound.

6. The electronic device according to claim 5, wherein the low refractive index metal-free compound is a substance selected from magnesium fluoride, calcium fluoride, silicon monoxide, silicon dioxide, and lithium fluoride, and the high refractive index metal-free compound is a substance selected from titanium oxide, zinc sulfide, tantalum oxide, zinc selenide, and zirconium dioxide.

7. The electronic device according to claim 5, wherein the metal-free vapor deposited film has a four-layer structure in which a silicon dioxide film and a zirconium dioxide film are alternately stacked on each other.

8. A watch comprising:
a light-transmissive clock face having a light refractive part formed from a concavo-convex portion on the bottom surface;
a solar panel provided underneath the clock face; and
a semi-transmissive reflective plate having both light permeability and light reflectivity provided between the clock face and the solar panel,
wherein the semi-transmissive reflective plate has a metal-free vapor deposited film.

9. A watch comprising:
a light transmissive clock face having a light refractive part formed from a concavo-convex portion on the bottom surface thereof;
a solar panel provided underneath the clock face;
an antenna device provided underneath the solar panel; and
a semi-transmissive reflective plate having both light permeability, light reflectivity, as well as radio-wave permeability provided between the clock face and the solar panel,
wherein the semi-transmissive reflective plate has a metal-free vapor deposited film.

10. The watch according to claim 8, wherein the metal-free vapor deposited film is formed on a surface of a light-transmissive base material provided between the clock face and the solar panel on the side of the clock face or the solar panel.

11. The watch according to claim 8, wherein a semi-transmissive reflective part made of the metal-free vapor deposited film is formed in stead of the semi-transmissive reflective plate on a surface of the solar panel on the side of the clock face.

12. The watch according to claim 8, wherein the metal-free vapor deposited film is structured by alternately stacking two or more layers of a low refractive index metal-free compound layer made from a low refractive index metal-free compound and a high refractive index metal-free compound layer made of a high refractive index metal-free compound having a higher refractive index than that of the low refractive index metal-free compound.

13. The watch according to claim 12, wherein the low refractive index metal-free compound is a substance selected from magnesium fluoride, calcium fluoride, silicon monoxide, silicon dioxide, and lithium fluoride, and the high refractive index metal-free compound is a substance selected from titanium oxide, zinc sulfide, tantalum oxide, zinc selenide, and zirconium dioxide.

14. The watch according to claim 12, wherein the metal-free vapor deposited film has a four-layer structure in which a silicon dioxide film and a zirconium dioxide film are alternately stacked on each other.
